(19) United States
(12) Patent Application Publication
(10) Pub. No.: US 2011/0214340 A1
(43) Pub. Date: Sep. 8, 2011

(54) Ant barrier for hummingbird feeders

(76) Inventor: Arnold Gregory Klein, Sandia Park, NM (US)

(21) Appl. No.: 12/932,553

(22) Filed: Feb. 26, 2011

Related U.S. Application Data
(60) Provisional application No. 61/339,342, filed on Mar. 4, 2010.

(51) Int. Cl. A01M 1/14

(52) U.S. Cl. 43/114

(57) ABSTRACT

A device used with nectar type bird feeders that acts as a barrier to prevent ant contamination. The device is positioned between the nectar feeder and the feeder support or is adapted to fit directly on a feeder or feeder support. The device is configured to hold a tacky polymer insert that is located to be in the only path available to the ants attempting to crawl to the feeder. The ants are prevented from entering and contaminating the nectar-feeder as they will not cross over the tacky polymer insert. The elastic, shape retaining tacky polymer insert is very easy to remove and can be handled directly where it can be cleaned with liquid soap and water if it become dirty or dust covered. The ant barrier device with the tacky polymer inserts can perform effectively as an ant barrier for several feeding seasons. Alternatively, a unitary structured, tacky polymer barrier may be constructed for direct attachment to a nectar-type birdfeeder or feeder support structure.

Applicant claims the benefit of Provisional application No. 61/339,342 filed Mar. 3, 2010.

### FIELD OF THE INVENTION

The present invention relates to a device to be used to prevent ants from contaminating nectar type bird feeders.

### BACKGROUND OF THE INVENTION

Nectar type bird feeders (hummingbird and oriole feeders) are extremely prone to getting contaminated by ants. This is a very well known problem to the bird feeding public and birdfeeder industry and as a result there are numerous commercial products that are specifically designed to prevent this problem. One of the most common devices is a water “moat” ant trap hung interposed above the feeder or designed integrally into the feeder (Ref. U.S. Pat. Nos. 4,691,665, 4,901,673, and 6,463,878). While water moat traps are effective, they require regular maintenance to clean and refill them. In dry regions, water moats will require daily refilling and they typically can go dry more frequently than the nectar in the feeder is replaced. Water moats can be effective, but many consumers find the disposal of drowned ants and the regular cleaning and refilling of these devices to be unpleasant and inconvenient. There are also physical barrier means incorporated into the feeder ports to prevent insect contamination as detailed in my U.S. Pat. Nos. 5,640,927 5,806,460 and 6,012,414 for Nectar Feeder Access Devices”. While these devices are effective, they must be configured for use with specifically adapted feeders and they require frequent and regular cleaning.

As ant contamination is a common problem, there are some “home remedy” measures such as putting vegetable oil or petroleum jelly on the feeder hanging cord, or around the perimeter of the feeder ports. There are also plastic “bell shaped” devices that are hung interposed between the feeder and the feeder hanging point and onto which the underside, the consumer is supposed to apply petroleum jelly. The petroleum jelly can melt in hot weather conditions and it or the vegetable oil usually become rancid. Unfortunately these home remedy type substances typically migrate to the feeder by being tracked by larger ants moving through them. These home remedy methods are only marginally effective in the short term and they tend to be messy, attracting dust and dirt, they require frequent, unpleasant cleaning and require regular cleaning and re- application. The use of petroleum jelly, grease or oily substances are specifically discouraged by Ornithologists because these materials can come into contact with and damage the plumage of wild birds.

One of the most popular products for the prevention of ant contamination is described in U.S. Pat. Nos. 4,782,662 4,890,416 and 5,274,950. This product marketed under the name Ant Guard™ is convenient and effective at preventing ants from getting into nectar feeders. Unfortunately, this product uses a “absorbent disk” treated with the wide spectrum insecticide “Permethrin”. The Permethrin insecticide is very toxic to bees and fish. Due to the fact that this product uses an insecticide barrier, it is unacceptable to environmentally conscious bird feeding consumers, Ornithologists and many specialty bird feeder retailers.

Finally, the devices disclosed in my U.S. Pat. No. 7,793,461 for an Insect Barrier with Disposable Adhesive Media are a convenient and low cost solution for keeping ants out of hummingbird feeders. While these devices are convenient and effective, the Ant Barrier for Hummingbird Feeders that uses a tacky polymer has the advantages of allowing for direct handling of the tacky polymer, an increased service life and a more consistent (non-trapping) tackiness. In the most basic embodiment, the device of the instant invention consists of only a tacky polymer barrier of unitary construction adapted to fit elastically on a nectar feeder or feeder support. The Ant Barrier for Hummingbird Feeders meets the need of bird feeding consumers for a very economical, convenient, non-toxic, multiple-feeding season solution for solving the specific and persistent problem of ant contamination of nectar type bird feeders.

### SUMMARY OF THE INVENTION

The instant invention is a convenient, non-toxic device specifically designed for keeping ants from entering and contaminating hummingbird and oriole feeders. The device uses a resilient “tacky polymer” insert that acts as a non-trapping barrier to ants attempting to pass over the insert to get to the sugar water in the nectar feeder. These “tacky” polymers are well known in the toy industry as used in “Wacky Wall Walker”, “Sticky Buddies”, “Snapper Hand”, and numerous other sticky toys. These “tacky” polymers are made from any number of different polymer resins that are specially formulated with high levels of plasticizers to be highly “tackified” or slightly sticky to the touch. They may be composed of an isoprene (a synthetic rubber), styrene-butadiene copolymer, polystyrene-butylene-ethylene copolymer, Plastisol (PVC)—all formulated for tackiness with plasticizers and tackifiers, and coloring materials. The “tacky polymer” as specified in this patent disclosure may be made of any plastic resin that can be formulated as elastic, shape retaining and being tacky to the touch.

Ants will not cross over these “tacky polymers” as they exhibit a behavioral adaptation that helps them to avoid getting trapped in tacky or sticky substances i.e. tree sap, etc.. The applicant has discovered that ants upon encountering a slightly tacky surface are disposed to back away rather than attempt crossing. The Ant Barrier for Hummingbird Feeders has been developed through hours of observation and a resulting insight into ant behavior: simply that ants, because of their methodical exploratory behavior will not attempt to cross, and typically will not be trapped by a tacky polymer barrier. Additionally, ants communicate with each other using pheromones. Once a trail is found to a food source, it is specifically identified and regularly traveled. When an established path to a food source is blocked by a barrier or obstacle, the foragers leave the path in an attempt to explore new routes. It seems that the ants coming back from a non-productive excursion leave some sort of pheromone message that this trail is not productive. The result of using an ant barrier is that the number of ants using the trail to the feeder drops off over time with fewer and fewer of them challenging the barrier. This is the reason that an ant barrier device is capable of functioning for an extended period without any maintenance.

In order to function as ant barriers, the tacky polymers disclosed in this application should be formulated to be shape retaining and not so sticky that the ants will be held fast or get trapped by them. It is important to locate and configure the tacky polymer barrier so that the ants are able to pull away and backtrack away from it. It is for this reason that the ant barrier device surfaces that are adjacent to the tacky polymer should be textured or made of a high friction material which allows ants to get enough traction to pull away. The relatively firm, shape retaining, and resilient consistency of the tacky polymer inserts allow for numerous options for the mounting of the polymer directly over or inside the ant barrier device or feeder. The shape retaining “tacky polymer” insert has the correct balance of adhesive properties to act as an effective barrier to the passage of ants when located with no alternative routes, between the nectar feeder and the feeder mounting structure.

### BRIEF DESCRIPTION OF THE DRAWINGS

The patent figures are intended to demonstrate some, but necessarily all of the design configurations for the ANT BARRIER FOR HUMMINGBIRD FEEDERS devices may have. These figures are not intended to show all of the potential device embodiments, but rather to demonstrate the design versatility of the instant invention.

FIG. 1 depicts an oblique view of the ant barrier device with a cylindrical tacky polymer inserts;

FIG. 2 depicts an oblique view of the ant barrier supporting member with adaptation to hold the cylindrical tacky polymer insert;

FIG. 3 depicts an oblique view of the ant barrier cylindrical tacky polymer insert;

FIG. 4 depicts an oblique view of the ant barrier supporting member with adaptation to hold the torus shaped tacky polymer inserts;

FIG. 5 depicts an oblique view of the ant barrier torus shaped tacky polymer inserts;

FIG. 6 depicts an oblique view of the ant barrier device with the torus shaped tacky polymer inserts in place;

FIG. 7 depicts a line drawing of the torus shaped tacky polymer inserts being directly handled;

FIG. 8 depicts a side view of a hummingbird feeder with a shrouded ant barrier device mounted on the feeder hook;

FIG. 9 depicts an exploded oblique view of an ant barrier supporting member and the torus shaped tacky polymer inserts adapted to fit within the device;

FIG. 10 depicts an oblique partial cutaway view of the ant barrier device of FIG. 8;

FIG. 11 depicts an oblique view of the shrouded ant barrier device attached to a feeder hanging cord;

FIG. 12 depicts a bottom side oblique cutaway view of the ant barrier device adapted to fit on a pole supported hummingbird feeder;

FIG. 13 depicts a top side oblique view of the ant barrier device adapted to fit on a pole supported hummingbird feeder;

FIG. 14 depicts a front view of a disassembled hummingbird feeder with a tacky polymer insert adapted for mounting directly on the feeder;

FIG. 15 depicts a front sectional view of a hummingbird feeder with a tacky polymer barrier device directly mounted on the feeder;

FIG. 16 depicts a front view of a hummingbird feeder with a tacky polymer barrier device adapted for direct mounting on a feeder-hanging hook;

FIG. 17 depicts a front view of a hummingbird feeder with a tacky polymer barrier device adapted for direct mounting on a feeder-support pole.

### DETAILED DESCRIPTION

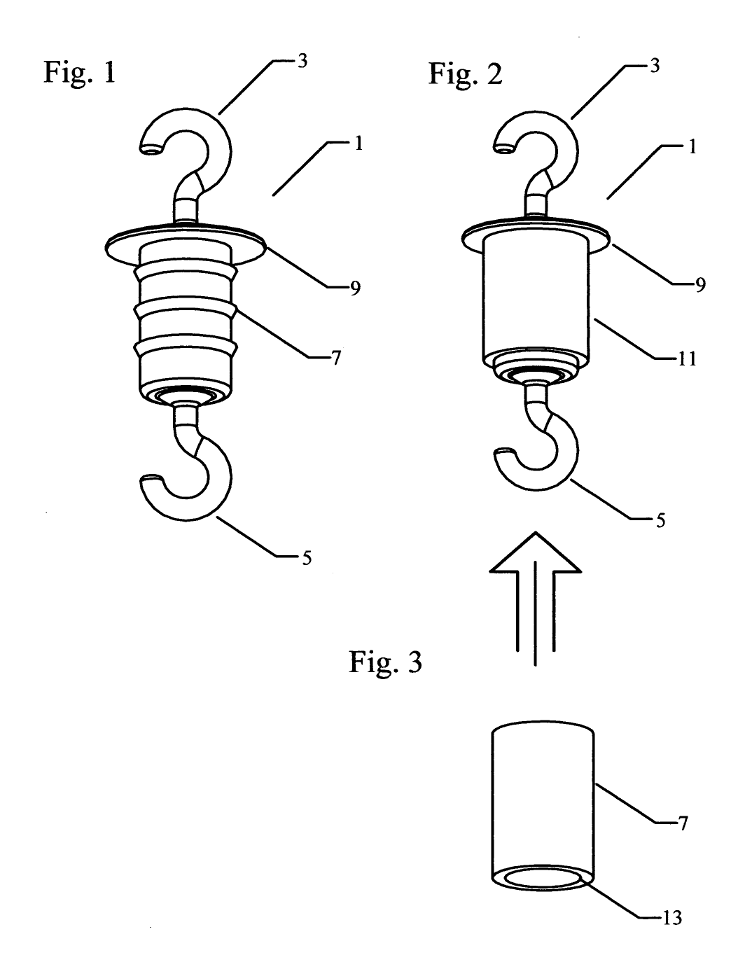

Referring to FIG. 1 there is shown an ant barrier supporting member 1 with upper hanging hook 3 and lower hanging hook 5 adapted for interposed mounting above the nectar feeder. The supporting stem or platform member 1 is adapted to hold a tacky polymer insert 7. As shown in FIGS. 2 and 3 the tacky polymer insert 7 is elastically fitted on the stem or platform member 1 by being pulled over the annular barbs 11. It can be seen in FIG. 3 that the tacky polymer insert 7 has an inside diameter 13 that is undersized to allow the insert to be elastically stretch fit and secured over the supporting member. This tacky polymer insert may be cast, molded or extruded and cut to length. It has been found through experiment that the tacky polymer inserts that are formulated firm enough to be elastic and shape retaining and to be slightly tacky will perform as a barrier to ants trying to get to the feeder. The ant barrier may have an integral dust cover or platform 9 as shown in FIGS. 1 and 2.

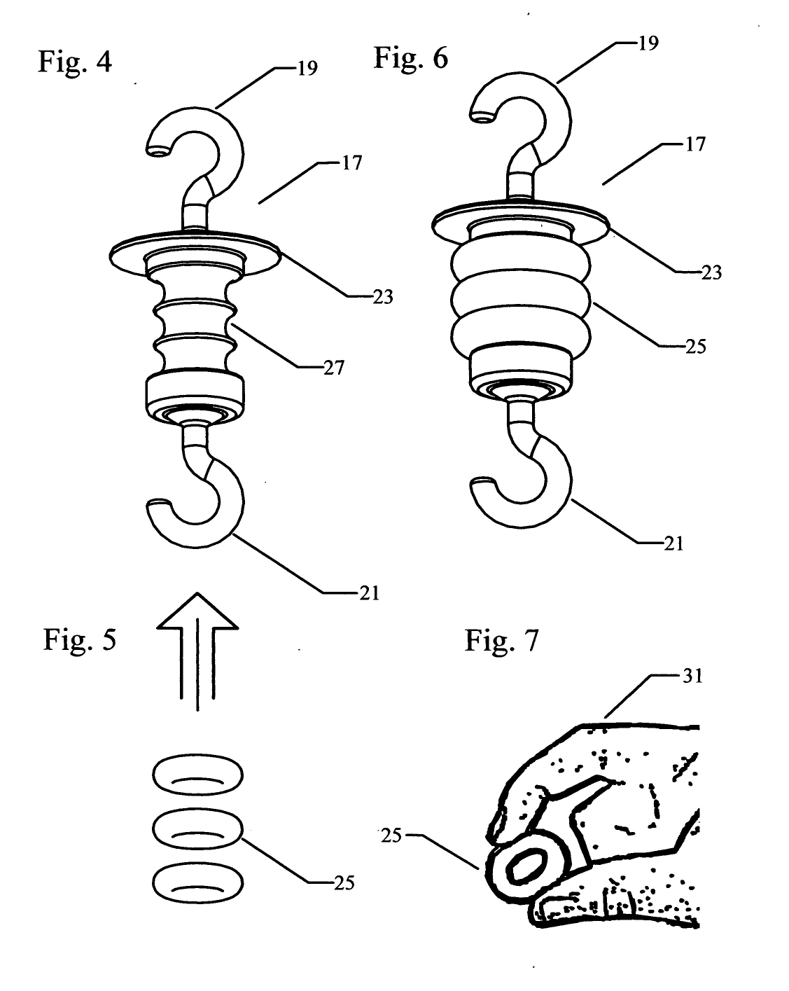

Referring to FIGS. 4, 5, 6 there is shown an ant bather supporting device 17 with upper hanging hook 19, lower hanging hook 21 and incorporated platform or dust shroud 23. In FIG. 6 the supporting member 17 is shown holding a series of torus or donut shaped tacky polymer inserts 25. It can be seen from the FIGS. 4-6 that the tacky polymer inserts 25 are elastically stretch fitted over the supporting member 17 at the annular grooves 27. The device of FIGS. 4-6 performs similarly to the device of FIGS. 1-3, but has a doughnut or torus form for the tacky inserts 25. One advantage of using the series of donut shaped tacky polymer inserts 25 is that these inserts may be formulated to have a progressively variable adhesion or tackiness property. This varying or progressive tackiness option may prove useful in areas with very large or numerous ants that require a tackier barrier. In the event that the progressively tackier inserts are used, they can be differentiated by being molded in different colors or color shades. The less sticky inserts will prevent the passage of small ants, while the stickiest insert will prevent even the largest strongest ants from passing over. The tacky polymer inserts can be made in virtually any shape configuration so long as when they are fitted on the adapted supporting device, they present an unbroken perimeter to prevent the passage of ants to the feeder.

Referring to FIG. 7 there is shown a hand 31 with finger and thumb holding a tacky polymer insert 25. The tacky polymer insert 25 is firm enough to be very elastic “stretchy” but still firm enough to retain the original molded or extruded shape. The elastic property of the inserts allows them to remain in position in or over the ant barrier device or directly attached to the feeder or feeder support. A primary advantage of using a tacky polymer barrier is that these tacky inserts can be handled directly without leaving behind any significant sticky or tacky residual material. They can be removed from the ant barrier device and cleaned with liquid soap and water.

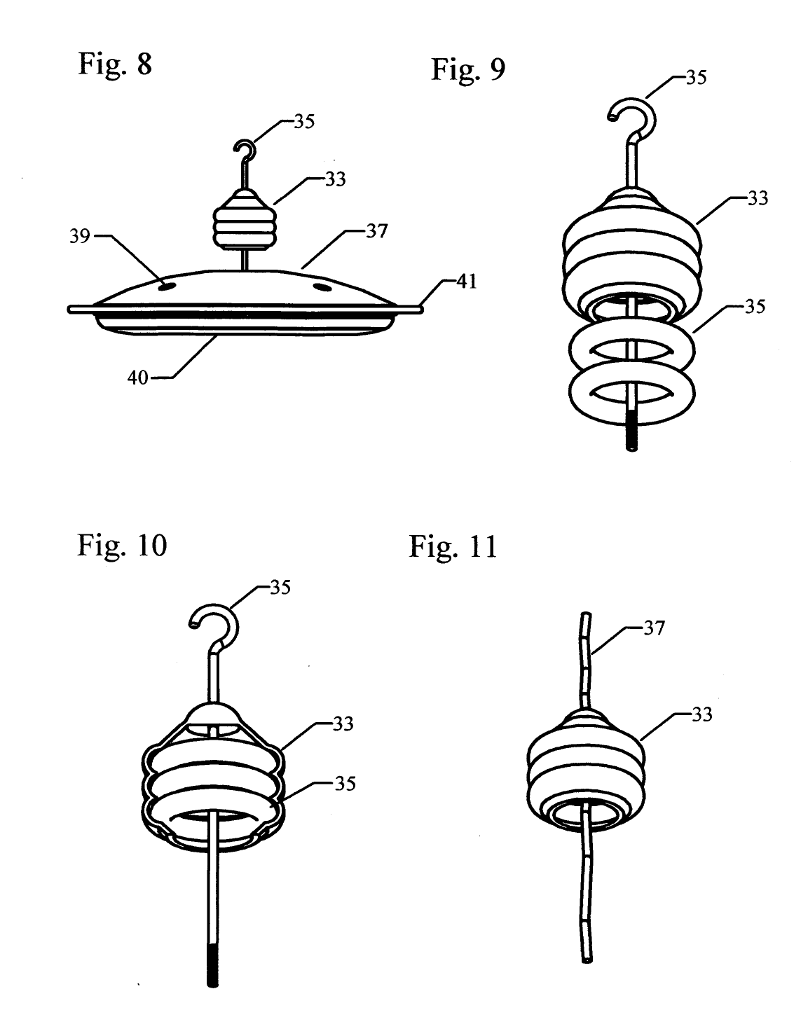

Referring to FIG. 8 there is shown a preferred embodiment of the ant bather device 33 adapted to friction fit on the hanging hook 35 of a hummingbird feeder 37. The hummingbird feeder 37 has one or more feeder access ports 39 and a perch 41. The ants are prevented from getting inside the feeder 37 by going through the ports 39 by the interposed placement of the bather device 33. Referring to FIGS. 9 and 10 there is shown the ant barrier device 33 adapted to fit on a feeder-hanging hook 35 and shaped to hold the tacky polymer inserts 35 within the device. The cutaway view of FIG. 10 shows that the tacky polymer inserts 35 are held in place by the form fitting interior walls of the ant barrier device 33. The tacky polymer inserts 35 are protected from the accumulation of dust, water or other debris by being placed within the interior of the device 33. Ants trying to get to the feeder ports 39 must pass over the outside and through the inside of the ant barrier device 33. As can be seen in FIG. 10 the ants are prevented from crawling through the inside of the device 33 by the tacky polymer insert or inserts 35 located within the device. FIG. 11 shows the ant barrier device 33 adapted to elastically fit and stay secure on a feeder cord 37 or hanging string. The ant barrier device having the tacky polymer inserts located within the device is a preferred embodiment of the instant invention because any tacky polymer will tend to attract dust and other debris. This dust or debris can be easily cleaned with soap and water from the tacky polymer but the shrouded devices will stay clean for an extended time period. In practice it is preferable to keep the tacky polymer insert(s) shrouded to prevent birds or flying insects from making contact with them. The ant barrier device 33 is configured to fit elastically on a non- adapted feeder hook or cord, but it can be made with a separate or integrally formed hook or eyelet suspension member for interposed mounting between a feeder and feeder support.

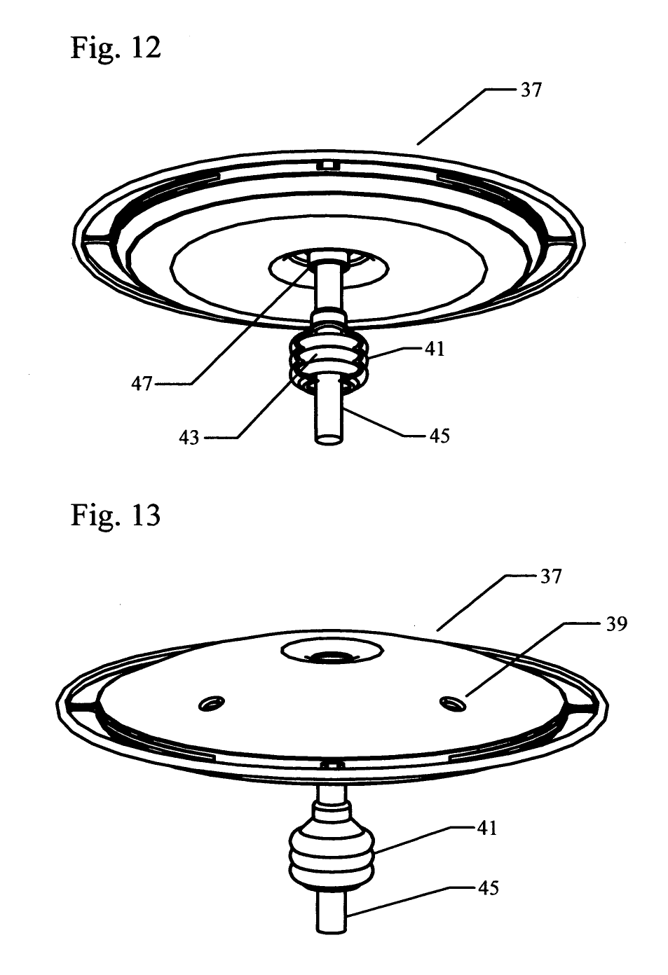

Referring to FIGS. 12 and 13 there is shown a nectar feeder 37 adapted to friction fit on a pole 45 as shown at 47. The ant barrier device 41 is adapted to fit elastically and stay secure on the feeder-mounting pole 45. The ant barrier device 41 is adapted to hold the tacky polymer inserts 43 within the interior of the device. It can be seen that ants are blocked from getting to the feeder ports 39 because their path up the pole to the feeder is blocked by the tacky polymer inserts 43 located within the ant barrier device 41.

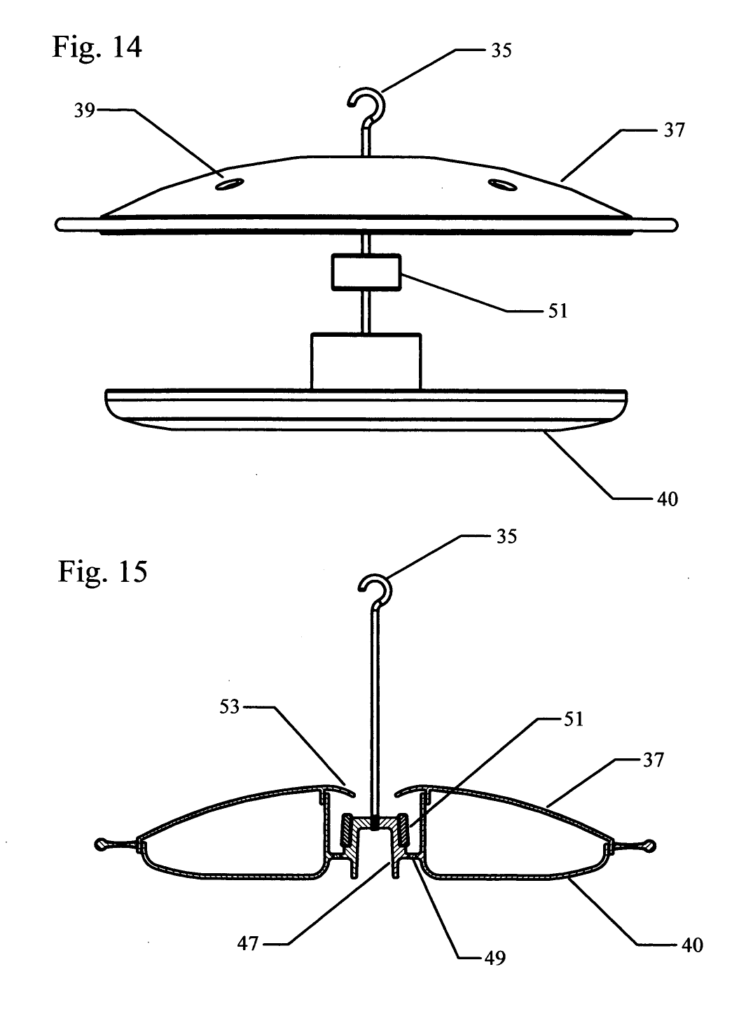

Referring to FIGS. 14 and 15 there is shown a nectar feeder 37 with feeder ports 39 and nectar reservoir bowl 40. The feeder bowl 40 is adapted to receive a tacky polymer insert 51 as shown in the FIG. 15. It can be seen at 53 that the feeder top extends over the tacky polymer insert 51 to protect it from the accumulation of dust or other debris. Many types of nectar feeders are configured for both pole mounting as seen at 47 or to be hung from a hanging hook 35. The feeder 37 shown in FIG. 15 has a small drain hole as shown at 49 to prevent the accumulation of rainwater. It can be seen that the location of the tacky polymer insert 51 adapted to fit directly on the feeder 37 will only protect from ants when the feeder is hanging using the feeder hook 35. An extension of the pole-mounting feature as shown at 47 would allow the tacky polymer insert 51 to be located below the feeder to protect from ant contamination when the feeder when is pole mounted.

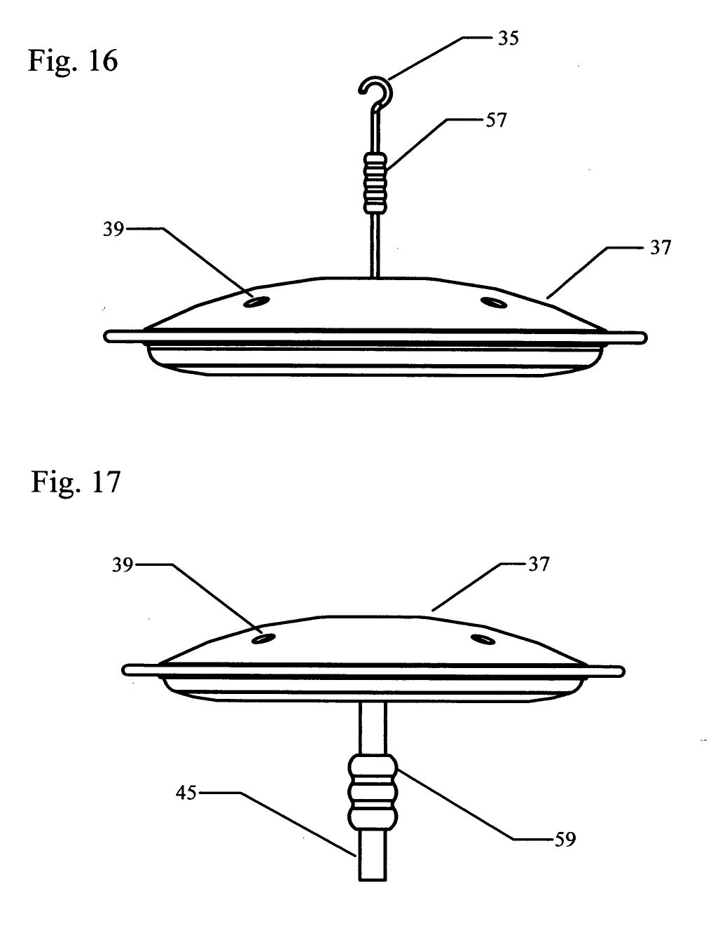

Referring to FIG. 16 there is shown a nectar type feeder 37 with a hanging hook 35 onto which is directly attached a unitary structured, tacky polymer ant bather 57. The ant barrier 57 is elastically stretched and held secure over the feeder hook 35. Referring to FIG. 17 there is shown a nectar type bird feeder 37 that is mounted on a pole 45. The unitary, tacky polymer ant barrier 59 is elastically stretched and held secure on the feeder-mounting pole 45. The very elastic tacky polymer allows for configurations that can be directly attached to a feeder or feeder support structure. While this unitary structured tacky polymer ant bather is very economical, it is not a preferred embodiment because the device is not well protected from the accumulation of dust or other debris. A unitary structured, tacky polymer ant barrier may have appeal to some consumers as a disposable product. Since the tacky polymer is relatively inexpensive, it is economically feasible to supply several unitary tacky polymer ant barrier devices that can be completely replaced on a routine basis.

It has been found that the Ant Barrier for Hummingbird Feeders perform best when they are supported using textured, or non-slippery surfaces adjacent to the tacky polymer insert. The ants need to be able to pull free of the tacky polymer insert when they encounter it. It has also been found that ants, especially the larger ones may slip and fall to the feeder below, especially in windy conditions if the outside of the barrier device is too smooth. Finally, although outside the scope of this patent application, the versatility of using a tacky polymer insert to perform as a barrier to ant contamination may be used in application for ant resistant pet food bowls, ant resistant barriers for hanging foodstuffs (campers/backpackers) and other localized ant barrier applications.

I have now described my invention in considerable detail, however others skilled in the art can devise and develop alternate and equivalent constructions. Hence, I desire my protection to be limited not by the constructions illustrated and described, but only by the proper scope of the appended claims.

What is claimed is:

1. In combination with a nectar type bird feeder, an ant barrier for use in preventing ant contamination of nectar type bird feeders, said ant barrier including:
a support member adapted for holding a shape retaining, tacky polymer insert, said tacky polymer insert being sufficiently tacky to act as a physical barrier to the passage of ants, said feeder including a mounting means positioned proximate to the feeder comprising a cord, hook or pole wherein said ant barrier device is adapted so as to position the device between the nectar type feeder and a nectar feeder support, wherein said device is disposed to act as a physical barrier to block ants from crawling to the nectar type feeder, whereby upon encountering said tacky polymer the ants retreat.

2. The combination of claim 1, wherein said ant barrier device includes a dust cover or platform.

3. The combination of claim 1, wherein said ant barrier device includes a protective shroud adapted to be mounted in an open end down position to prevent collection of dust, water or other debris on said tacky polymer insert.

4. The combination of claim 1, wherein said ant barrier device is adapted to friction fit said device on a nectar feeder support.

5. The combination of claim 1, wherein said ant barrier device includes tacky polymer inserts of varying tackiness.

6. The combination of claim 1, wherein the mounting means comprises hooks or eyelets.

7. In combination with a nectar type bird feeder, an ant barrier for use in preventing ant contamination of nectar type bird feeders, said ant barrier including:
a shape retaining, tacky polymer barrier, said tacky polymer barrier being sufficiently tacky to act as a physical barrier to the passage of ants, said feeder including a mounting means positioned proximate to the feeder comprising a cord, hook or pole wherein said ant barrier device is adapted to elastically, friction fit said device on a nectar feeder so as to position the device between the nectar type feeder and a nectar feeder support, wherein said device is disposed to act as a physical barrier to block ants from crawling to the nectar type feeder, whereby upon encountering said tacky polymer the ants retreat.
